(19) United States
(12) Patent Application Publication
(10) Pub. No.: US 2026/0278227 A1
(43) Pub. Date: Sep. 17, 2026

(54) PROCESS TECHNOLOGY COMPUTER AIDED DESIGN WITH IMPROVED AFTER-ETCHING INSPECTION MODLEING

(71) Applicant: Taiwan Semiconductor Manufacturing Company, Ltd., Hsinchu (TW)

(72) Inventors: Yu-Fu Wang, New Taipei (TW); Nuo Xu, San Jose, CA (US); Yuan Hao Chang, Hsinchu (TW); Kian Chuan Ong, Hsinchu (TW); Zhiqiang Wu, Chubei (TW); Hsiang-Liang Lin, Kaohsiung (TW)

(21) Appl. No.: 19/078,357

(22) Filed: Mar. 13, 2025

(51) Int. Cl. G06F 30/3308; G06F 115/06; G06F 119/18

(52) U.S. Cl. CPC G06F 30/3308; G06F 2115/06; G06F 2119/18

(57) ABSTRACT

In process technology computer-aided design, a simulated three-dimensional after etch inspection (AEI) profile is generated by simulating etching of a semiconductor structure represented by a three-dimensional after-development inspection (ADI) profile using an iterative three-dimensional physical etch simulation. The simulated three-dimensional AEI profile is compared with a desired AEI profile or with an acquired AEI image. The iterative three-dimensional physical etch simulation may be a Particle Monte Carlo (PMC) etch simulation. The iterative three-dimensional physical etch simulation may be a Process Emulation (PE) etch simulation. The generating of the simulated three-dimensional AEI profile may further include simulating trimming of a patterned layer of the semiconductor structure performed by applying an ion beam treatment to the patterned layer. The simulation of the trimming may include modeling mechanical deformation of the patterned layer.

### BACKGROUND

The following relates to process technology computer-aided design (TCAD), to simulation of photolithographically controlled etching in process TCAD, and to the like.

Process technology computer-aided design (TCAD) is a technology which models semiconductor fabrication processes such as doping profiles produced by doping processes, and photolithographic processes. In one nonlimiting illustrative application, process TCAD is employed in electronic design automation to optimize processing parameters and/or components used in semiconductor processing (for example, optimizing a photolithography mask layout, optical exposure time, etching parameters, and/or so forth in the case of photolithographic processing such as photolithographically defined pattern etching). In another nonlimiting illustrative application, TCAD technology can provide reference information for comparing test results in semiconductor fabrication quality assurance (QA) or quality control (QC). Various process TCAD systems and methods have been in commercial use for decades for bipolar, NMOS, CMOS, and other types of integrated circuit (IC) design and fabrication.

The following discloses certain improvements.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 diagrammatically illustrates a process technology computer-aided design (TCAD) system.

FIG. 2 diagrammatically illustrates a nonlimiting illustrative example of etch simulation using Particle Monte Carlo (PMC) etch simulation.

FIG. 3 diagrammatically illustrates a nonlimiting illustrative example of etch simulation using Process Emulation (PE) etch simulation.

FIGS. 4A, 4B, and 4C diagrammatically illustrate nonlimiting illustrative implementations of a PMC etching simulation.

FIG. 5 diagrammatically illustrates a nonlimiting illustrative implementation of a PE etching simulation.

FIG. 6 presents a table of some nonlimiting illustrative models for the sputter yield of charged particles used in etching as a function of angle.

FIG. 7 diagrammatically presents examples of process TCAD etch simulations using PMC and PE etch simulation.

FIG. 8 diagrammatically presents an example of post-processing of a TCAD etch simulation to extract contour metrology.

FIG. 9 diagrammatically presents another example of post-processing of a TCAD etch simulation to extract contour metrology.

FIG. 10 diagrammatically presents another example of post-processing of a TCAD etch simulation to extract contour metrology.

FIG. 11 diagrammatically shows an etch simulation of a process TCAD implemented parallelized on hardware accelerators.

FIG. 12 diagrammatically shows an etch simulation of process TCAD utilized to optimize an etch process recipe for use in IC fabrication.

FIG. 13 diagrammatically shows an etch simulation of process TCAD utilized as a reference for performing after-etch inspection (AEI) quality control (QC).

FIGS. 14A and 14B diagrammatically illustrates two approaches for achieving a desired critical dimension in an IC pattern-using two photolithographic patterning steps (FIG. 14A); and using a single photolithographic patterning step and pattern trimming (FIG. 14B).

FIG. 15 diagrammatically illustrates pattern trimming with mechanical deformation.

FIG. 16 diagrammatically illustrates TCAD simulation including photoresist pattern trimming, hard mask etching, and hard mask trimming in accordance with a nonlimiting illustrative embodiment.

FIG. 17 diagrammatically illustrates a nonlimiting illustrative example of parameters used in the TCAD simulation of FIG. 16.

FIG. 18 diagrammatically illustrates the photoresist mechanical deformation simulation of FIG. 17 in accordance with one nonlimiting illustrative embodiment.

FIG. 19 diagrammatically illustrates TCAD simulation of an etch including pattern trimming with mechanical deformation, followed by a deposition step, in accordance with a nonlimiting illustrative embodiment.

FIG. 20 diagrammatically illustrates ion beam trajectory modeling.

FIG. 21 diagrammatically illustrates a nonlimiting illustrative example of simulation of trimming of a blanket layer of photoresist including mechanical deformation.

FIG. 22 diagrammatically illustrates a nonlimiting illustrative example of simulation of trimming of patterned photoresist including mechanical deformation, for the three ion beam tilt angles: 0 degrees; 30 degrees; and 60 degrees diagrammatically shown in FIG. 20.

### DETAILED DESCRIPTION

The following disclosure provides many different embodiments, or examples, for implementing different features of the provided subject matter. Specific examples of components and arrangements are described below to simplify the present disclosure. These are merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Process Computer Aided Design (TCAD) tools use physics-based models and computer simulations to quantitatively evaluate semiconductor device fabrication processes and related information such as material properties. Process TCAD tools are used to predict experimental results or trends without actually performing the experiments, thus reducing development cycles and saving resources, and can be used in support roles in semiconductor research and development.

Semiconductor patterning is the process of transferring a desired pattern from a photolithographic mask onto a wafer in order to define features of an integrated circuit (IC). Semiconductor patterning includes photolithography (photoresist-PR coating, optical exposure to from a latent image in/on the photoresist coating, baking and development, also referred to herein as photolithographic processing), followed by selective etching. In some cases, the semiconductor patterning workflow may include depositing one or more hard mask layers prior to coating with the photoresist. The etching may include, for example, etching openings in the hard mask layer or layers with one or more etchants that are selective for the material of the hard mask, followed by etching underlying material exposed by the hard mask openings using a different etchant that does not etch the hard mask material.

In general, the term “semiconductor structure” as used herein encompasses the structure that is (at least partly) etched by the etching process. The semiconductor structure may include, by way of nonlimiting illustrative example, one or more of: a base semiconductor material (e.g., a semiconductor wafer such as a silicon wafer, or a semiconductor layer or so forth); one or more dielectric or insulator materials; one or more metals; other types of semiconductor materials (e.g., a heteroepitaxial semiconductor layer); and/or so forth. The semiconductor structure may optionally include a hard mask (which itself may comprise a dielectric or other type of material), the patterned and developed photoresist coating, and/or so forth.

The etching may, for example, be performed in the process chamber of a plasma etching tool. The etching selectively removes one or more materials from the surface of the semiconductor wafer (or other semiconductor structure) to create patterns that form the basis of the electronic, photonic, and/or other devices of an IC under fabrication. In dry plasma etching, a plasma generates electrically charged particles (e.g., electrons, ions, radicals, or some combination thereof) which are driven to sputter material from the semiconductor structure by a radio frequency (RF) electromagnetic field and/or other electrostatic and/or electromagnetic field(s) formed in the plasma etching chamber.

To maintain quality control (QC), also referred to herein as quality assurance (QA), inspections are performed at designated points in a semiconductor fabrication process. After Development Inspection (ADI) refers to a wafer pattern dimension and geometry QC check performed after a photolithographic process (exposure-baking-development). After Etching Inspection (AEI) refers to a QC check process performed after etching steps, usually close to the final pattern of electron devices. As used herein, the process TCAD includes ADI to AEI simulation flow, which includes lithography and etching simulations using empirical or rigorous (physics-based) models. The simulation results may be verified using experimental data (e.g., electron microscopy images acquired as part of the ADI and AEI) in a timely manner.

The photolithographic pattern and latent image are ideally two-dimensional, and some ADI to AEI process flow designs use empirical models based on two-dimensional layout geometry. As recognized herein, however, such two-dimensional simulation can be over-simplified and introduces hidden assumptions, such as the assumption that the etch is uniform, and that the ADI to AEI gap can be viewed as a constant bias field. These hidden assumptions and simplifications can lead to inaccuracies in the ADI to AEI simulation results.

In process TCAD embodiments disclosed herein, a simulated three-dimensional AEI profile is generated by simulating etching of a semiconductor structure represented by a three-dimensional ADI profile using an iterative three-dimensional physical etch simulation. In some embodiments, the ADI to AEI simulation includes etching-related reactions such as chemical etch rate and plasma sputter yield on different materials, and selectivity on different materials. In some embodiments, the ADI to AEI simulation includes a simulated structure that is three-dimensional and includes effects along height/thickness direction.

Ab initio based methodologies such as Density Functional Theory, Molecular Dynamics et cetera which model atomic-resolution dynamics consume substantial computing power, and may be limited in both temporal (picosecond to nanosecond) resolution and spatial (nanometer) resolution. In practice, process steps from ADI to AEI usually take place on a time scale of an hour or longer temporally, and are typically around 10-1000 micron in spatial scale. In improvements disclosed herein, rigorous three-dimensional ADI to AEI simulation models are employed, which are both accurate for key patterning and etching physics and feasible in turn-around time (TAT) for practical-scale applications.

In some embodiments, a rigorous model for etch process is employed, which connects the ADI lithography/resist to patterning process simulations and is based on three-dimensional structures and physical models, to predict ADI to AEI results. Some disclosed ADI to AEI simulation workflows implement post-processing steps with algorithms to smooth simulated voxel data to surfaces and curves in order to extract key geometrical indexes stably. For example, at least one edge of the simulated three-dimensional AEI profile may be fitted with a parametric shape or line to smooth the edge.

Some disclosed ADI to AEI simulation workflows and related applications provide design rule generation and verification at early technology node development.

Some disclosed ADI to AEI simulation workflows and related applications provide a prediction of potential defects or hot spots detection during interim manufacturing stages for both mature and new technology nodes.

Advantageously, the disclosed ADI to AEI simulation embodiments effectively balance between accuracy in results versus turn-around time (TAT), and their use can reduce the number of experimental trials employed to achieve the desired process optimization, leading to more cost-effective smart manufacturing.

The disclosed ADI to AEI simulation embodiments generate a simulated three-dimensional AEI profile by simulating etching of a semiconductor structure represented by a three-dimensional ADI profile using an iterative three-dimensional physical etch simulation. The three-dimensional ADI profile represents a semiconductor structure after processing by a photolithographic processing sequence, which includes coating the semiconductor structure with photoresist, optical exposure of the photoresist coating to form a latent image in and/or on the photoresist coating, optional baking of the photoresist coating, and development of the latent image. The disclosed ADI to AEI simulation embodiments can be utilized to simulate substantially any type of semiconductor patterning, such as deep ultraviolet (DUV) lithography in which the optical exposure employs DUV light (optionally including double and/or quadruple patterning), extreme ultraviolet (EUV) lithography in which the optical exposure employs EUV light, and so forth. The three-dimensional ADI profile can represent substantially any type of semiconductor structure, for example optionally including one or more hard mask layers, optionally including three-dimensional structures (optionally even before commencement of the etching) such as finFET or gate-all-around (GAA) transistor structures, various combinations thereof, and/or so forth.

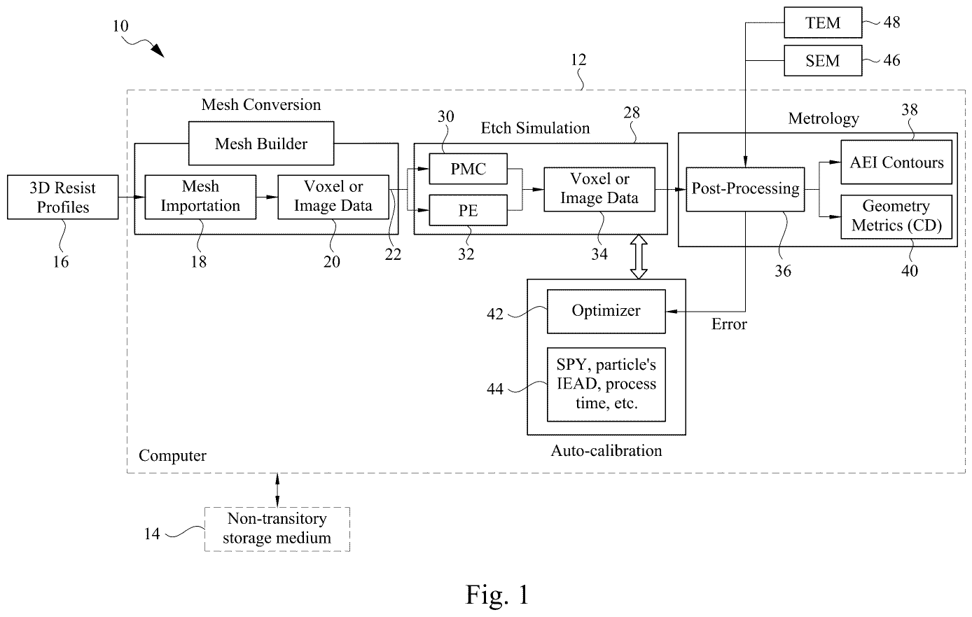

With reference to FIG. 1, a process technology computer-aided design (TCAD) system 10 is implemented by a computer 12, which may be a desktop or notebook computer, a server computer, a plurality of computers such as a computer cluster or a cloud computing resource, various combinations thereof, or so forth, as some nonlimiting illustrative examples. FIG. 1 depicts the process TCAD system 10 by way of functional blocks implemented by instructions stored on a non-transitory storage medium 14 which are read and executed by the computer 12. The non-transitory storage medium 14 may be a magnetic storage medium such as a hard disk or a redundant array of inexpensive disks (RAID), an optical storage medium such as an optical disk, an electronic storage medium such as a flash memory, various combinations thereof, or so forth, as some nonlimiting illustrative examples.

The process TCAD system 10 receives as input a three-dimensional (3D) resist profile 16 representing the patterned photoresist used to perform the patterned etch to be simulated. The 3D resist profile 16 may, for example, come from lithography simulations including simulated light exposure, post-exposure baking and development steps. In the illustrative example, the 3D resist profile 16 is represented by a mesh which is imported in an operation 18 and converted to voxel (i.e., 3D image) data in an operation 20. In other contemplated embodiments, the 3D resist profile 16 may be provided directly as voxel (i.e., 3D image) data, in which case the conversion operation 20 is suitably omitted. The output is a simulated 3D image 22 of the structure after photolithographic exposure, baking, and development—that is, a 3D ADI profile 22 which is representative of which would be expected to be observed in after-development inspection, e.g., by electron microscopy.

The 3D ADI profile 22 serves as input to an etch simulation 28 which uses an iterative three-dimensional physical etch simulation such as illustrative Particle Monte Carlo (PMC) etch simulation 30 and/or Process Emulation (PE) etch simulation 32 to simulate etching of a semiconductor structure represented by the 3D ADI profile 22. The output of the etch simulation 28 is a simulated 3D after etch inspection (AEI) profile 34 represented as voxel (i.e., 3D image) data. The etch simulation 28 provides rigorous modeling of the etch process, which connects lithography and photoresist to patterning process simulations and is based on 3D structures and physical models, to predict the ADI to AEI results.

The 3D AEI profile 34 is optionally post-processed by post-processing 36, which may by way of nonlimiting illustrative example include smoothing of the voxel data to form continuous and conformal curves or surfaces 38 for metrology purposes. This may optionally be followed by quantitative analysis 40 such as determining one or more geometry metrics.

An optimizer 42 can synchronize iterations to tune model parameters 44 of the etch simulation 28, such as sputtering yield (SPY), particle ionic energy and angle distribution (IEAD), process time, and so forth, to match the 3D AEI profile 34 produced by the etch simulation 28 with empirical data, such as one or more scanning electron microscopy (SEM) images 46 and/or one or more transmission electron microscopy (TEM) images 48 of a semiconductor structure that has undergone the photolithographic and etching processing.

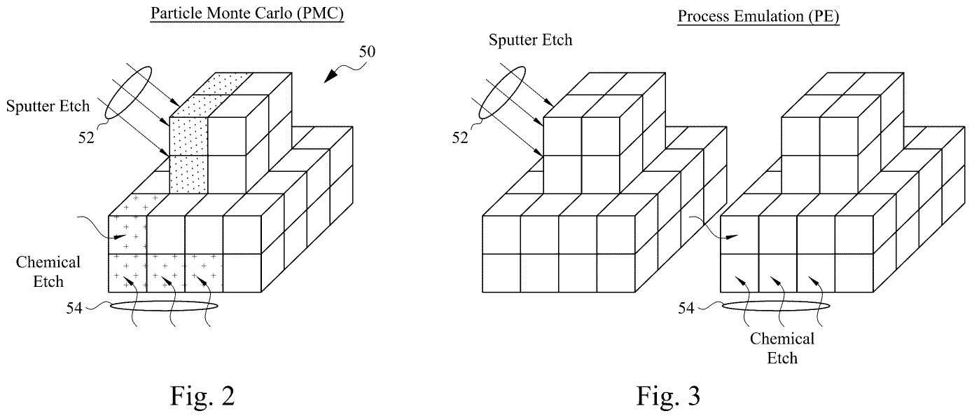

FIG. 2 diagrammatically illustrates a nonlimiting illustrative example of etch simulation using the Particle Monte Carlo (PMC) etch simulation 30 of FIG. 1. The PMC etch simulation 30 is applied to a semiconductor structure 50. As previously noted, the semiconductor structure 50 is the structure that is (at least partly) etched by the etching process, and may include, by way of nonlimiting illustrative example, one or more of: a base semiconductor material (e.g., a semiconductor wafer such as a silicon wafer, or a semiconductor layer or so forth); one or more dielectric or insulator materials; one or more metals; other types of semiconductor materials (e.g., a heteroepitaxial semiconductor layer); and/or so forth. The semiconductor structure 50 may optionally include a hard mask (which itself may comprise a dielectric or other type of material), the patterned and developed photoresist coating, and/or so forth. The semiconductor structure 50 is represented in the etch simulation by voxels, and (at least at the start of the etch simulation) the semiconductor structure 50 may be represented by the 3D ADI profile 22. The PMC etching simulation 30 is a statistical sampling approach, which generates trajectories 52 of individual electrically charged particles (e.g., electrons, ions, radicals) used in the etching, and tracks their interactions with surfaces of the semiconductor structure (e.g., as represented by the 3D ADI profile 22), to thereby simulate plasma-surface interaction processes. The PMC simulation 30 accounts for the physical properties of the surface of the semiconductor structure, such as its topography, roughness, composition, and so forth. The PMC simulation 30 also accounts for the plasma conditions employed during the etching, such as flux of the charged particles, ionic energy and angle distributions (IEAD, and/or so forth. In addition to modeling the sputter etching due to kinetics of the electrically charged particles following the trajectories 52, the PMC etching simulation 30 may also optionally simulate chemical etching 54 due to chemical reactions that may occur during the etching process.

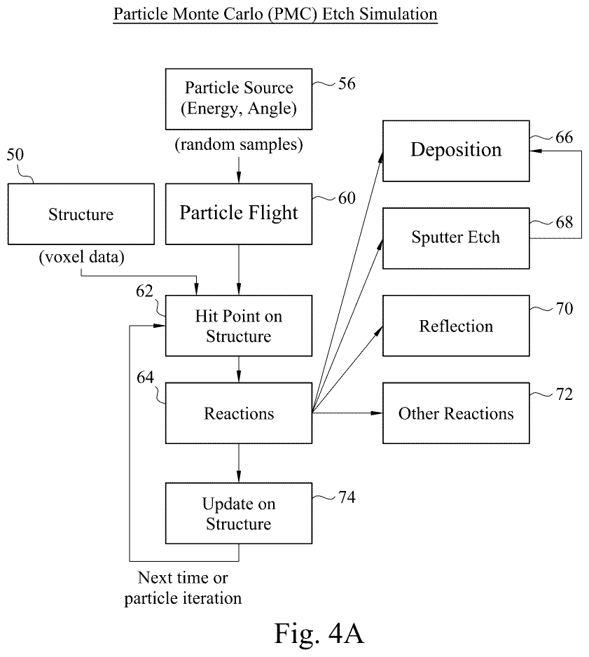

FIG. 3 diagrammatically illustrates a nonlimiting illustrative example of etch simulation using the Process Emulation (PE) etch simulation 32 of FIG. 1. The PE etch simulation 32 is applied to the semiconductor structure 50 previously described, and in some embodiments (at least at the start of the etch simulation) the semiconductor structure 50 may be represented by the 3D ADI profile 22. The PE etching simulation 32 employs a process emulation simulation methodology which simulates dynamics of the etching process by breaking the semiconductor structure 50 down into discrete voxels, each of which contains a set of rate equations describing its updates at the next step of the iterative PE etch simulation 32. By adjusting the voxel size and further accounting for fractional voxel effects, the PE simulation 32 can be performed under multiple scales. The PE simulation 32 can simulate both sputter etching due to kinetics of the electrically charged particles following the trajectories 52, and chemical etching 54 due to chemical reactions that may occur during the etching process, by incorporating both processes into the process emulations rate equations.

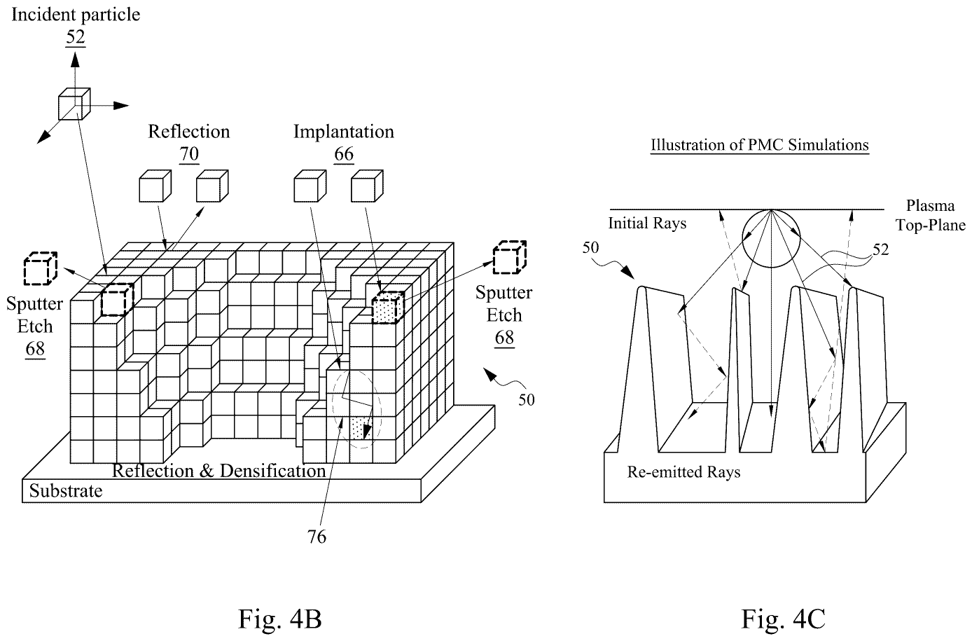

With reference to FIGS. 4A, 4B, and 4C, a nonlimiting illustrative implementation of the PMC etching simulation 30 of FIG. 2 is illustrated. FIG. 4A shows a flowchart of a PMC etching simulation. The inputs include the (voxel representation of) the semiconductor structure 50 and particle source (energy and angle) information 56 on the sputter etch particles and trajectories 52. Particle flights 60 (i.e., sample trajectories 52) are simulated, and the impact points 62 where the trajectories impact the semiconductor structure 50 are determined, along with the resulting etch reactions 64 such as material deposition 66 (e.g., ion implantation 66 in one illustrative example), sputter etching 68, particle reflections 70 (corresponding to secondary trajectories), and other reactions 72 (e.g., chemical reactions 54). In some embodiments, Gillespie's algorithm is used to randomly select the reactions 64. In each iteration of the PMC etching simulation 30, the semiconductor structure 50 is updated 74 based on the reactions 64 of the Monte Carlo-simulated particle trajectories. FIG. 4B diagrammatically illustrates the incident particle 52 (as described by the particle source 56 and particle flight 60 of the PMC etch simulation flowchart of FIG. 4A) impinging on the semiconductor structure 50. The sputter etching 68 and reflection 70 reactions are also diagrammatically illustrated in FIG. 4B, along with potential ion implantation 66 reactions. During ion implantation 66, incident particles (e.g., ions) are deposited (e.g., implanted) in the semiconductor structure 50. During the ion implantation 66, the incident particles may undergo interactions 76 such as reflections and/or produced material densification in which the region of the semiconductor structure 50 into which the ions are implanted is densified. FIG. 4C diagrammatically shows another example. In the example of FIG. 4C, the semiconductor structure 50 includes grooves 78 undergoing etching and/or ion implantation. FIG. 4C also diagrammatically shows a representation of the plasma by a plasma top-plane, along with a representation of the distribution of angles 56 of sample trajectories 52 of the ionized particles being emitted by the plasma performing the plasma etching and/or ion implantation.

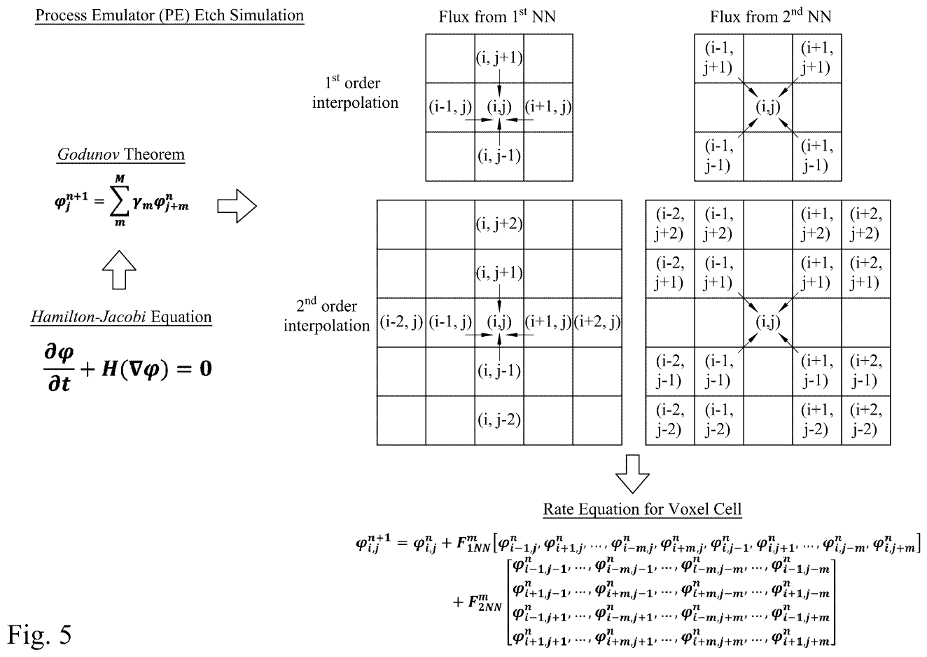

With reference to FIG. 5, a nonlimiting illustrative implementation of the PE etching simulation 32 of FIG. 2 is illustrated. The iterative 3D PE etch process emulation 32 computes a volume parameter φ_{i,j,k} as a function of three-dimensional voxel location (i, j, k) using a Hamilton-Jacobi equation given by:

$$\frac{\partial φ}{\partial t} + H ( ∇ φ ) = 0 \qquad ( 1 )$$

where ∇φ is a gradient of the volume parameter φ_{i,j,k} and

$$\frac{\partial φ}{\partial t}$$

is a partial derivative of the volume parameter φ_{i,j,k} with respect to time t. The characteristics of volume parameter φ_{i,j,k} include the material of the corresponding volume (e.g., photoresist material, hard mask material, silicon or other semiconductor material, or so forth depending on the location of volume parameter φ_{i,j,k} in the semiconductor structure). The Hamiltonian H of overall spatial differential term ∇φ in the Hamilton-Jacobi Equation (1) ensures the solution is smooth and conserves physical properties (etch flux). In the nonlimiting illustrative example of FIG. 5, the Hamilton-Jacobi equation is solved using the Godunov Theorem:

$${φ}_{j}^{n + 1} = {\sum }_{m}^{M} {γ}_{m} {φ}_{j + m}^{n} \qquad ( 2 )$$

where m is the interpolation order, and is the voxel index. The parameter γₘ is suitably chosen to ensure numerical stability and high efficiency (e.g. 1st vs. 2nd order, long or narrow neighbor range). The Godunov Theorem of Equation (2) is suitable for a continuum partial differential equation (PDE) solution with discretization on a voxel mesh, under uniform spatial and temporal stepping numerical schemes. FIG. 5 presents a rate equation for voxel cell (i, j), and diagrammatically depicts the 1^{st} order interpolation and 2^{nd} order interpolation for the PE simulation for a simplified two-dimensional example, for which the volume parameters are φ_{i,j}. The illustrative PE simulation accounts for nearest neighbor (i.e., 1^{st} NN) and next-nearest neighbor (i.e., 2^{nd} NN) interactions. Extension of this simplified two-dimensional example to the 3D PE simulation 32 is straightforward, with the voxels of the 3D PE etch simulation being of the three-dimensional form φ_{i,j,k}.

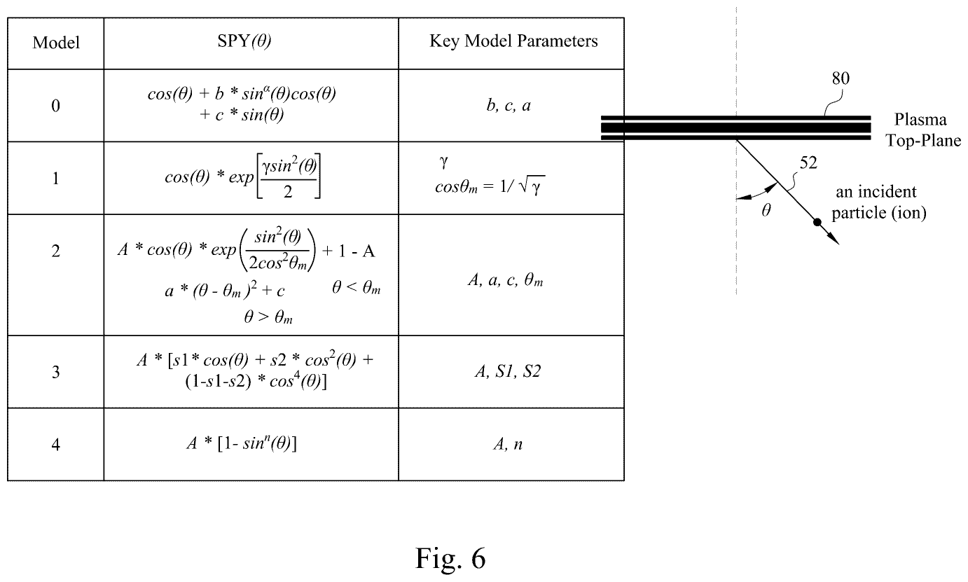

With reference now to FIG. 6, some suitable mathematical formulations for the sputter yield (SPY) as a function of trajectory angle (θ) are shown. As indicated in FIG. 6, the angle (θ) of the particle trajectory 52 is respective to the surface normal of the plasma top plane 80 from which the charged particle is emitted (and, although not shown, also normal to the semiconductor wafer being etched), that is, θ=0 corresponds to normal incidence of the charged particle on the wafer. In the table of FIG. 6, each Model #corresponds to a mathematical formulations for the sputter yield SPY(θ) that may be used in the PMC etch simulation 30 and/or PE etch simulation 32. The rightmost table column “Key model parameters” are tunable parameters of the model, and may for example be optimized for a particular etch by the optimizer 42 of the process technology TCAD system of FIG. 1. The choice of model for sputter yield SPY(θ) is suitably made to most closely agree with the actual distribution of charged particles produced by the etching chamber used to perform the etching, and/or based on the number of parameters (e.g., a sputter yield SPY(θ) that has more parameters may enable closer fitting but can increase complexity of the optimization performed by the optimizer 42 of FIG. 1).

With reference back to FIG. 1, in some embodiments the etch simulation 28 is implemented using the PMC etch simulation 30 alone. In some embodiments the etch simulation 28 is implemented using the PE etch simulation 32 alone. In some embodiments the etch simulation 28 is implemented using both the PMC etch simulation 30 and the PE etch simulation 32. The PMC etch simulation 30 excels in rigor and physical accuracy, and can reveal process margins (window). The PE etch simulation 32 provides fast turn-around time (e.g., for calibrations). Hence, in some embodiments the PMC etch simulation 30 and the PE etch simulation 32 are used together to provide complementary benefits. For example, the fast PE etch simulation 32 can be used for fast optimization, while the PMC etch simulation 30 can be used for situations where high accuracy is desired.

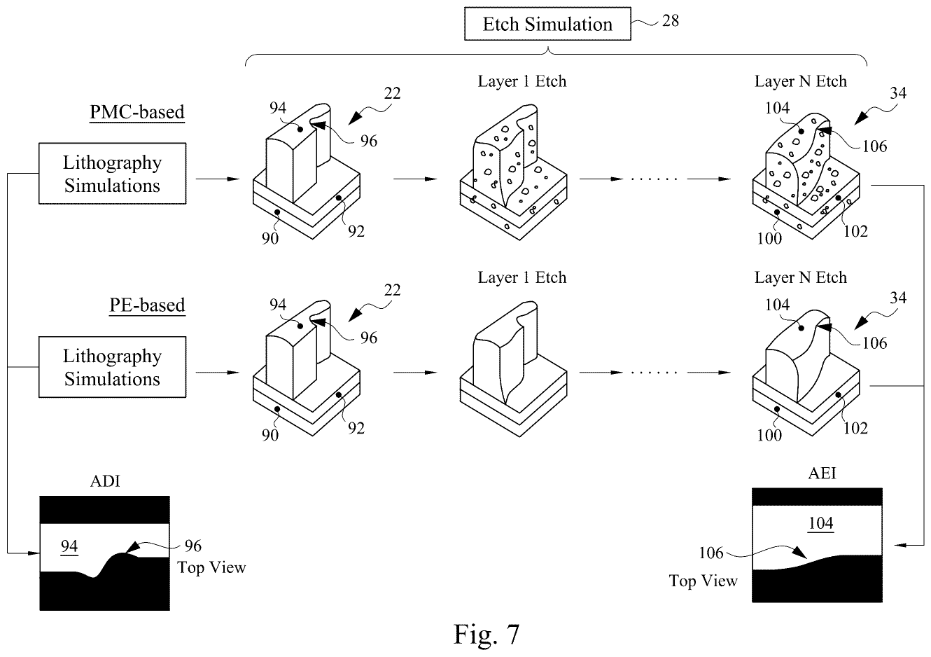

With reference now to FIG. 7, further nonlimiting illustrative examples of the etch simulation 28 are shown, for a representative semiconductor structure has a 3D ADI profile 22 representing a silicon layer 90 to be etched, a hard mask 92 made of a dielectric material such as silicon oxide (SiOx), silicon nitride (SiN), silicon carbide (SiC), silicon oxynitride (SiON), or so forth, and photoresist 94. The illustrative 3D ADI profile 22 of FIG. 7 includes a relatively complex contour 96 (i.e., a contour 96 with a region of strong curvature) which is to be formed in the silicon layer 90 to be etched. The top view illustrates the curvature 96 in two-dimensions, but as previously discussed the 3D ADI profile 22 contains more detailed three-dimensional information on the after-development structure. The illustrative etch simulation 28 performs N iterations of etch simulation, using either the PMC etch simulation 30 (top row) or the PE etch simulation 32 (bottom row). The 3D AEI profile 34 shows the simulated etching result in each case, including the etched curve 106, and a top view also shown in FIG. 7 illustrates the curvature 106 in two-dimensions. As seen, the simulated etch demonstrates that substantial detail of the sharp curvature 96 is lost (i.e., smoothed out) by the etching.

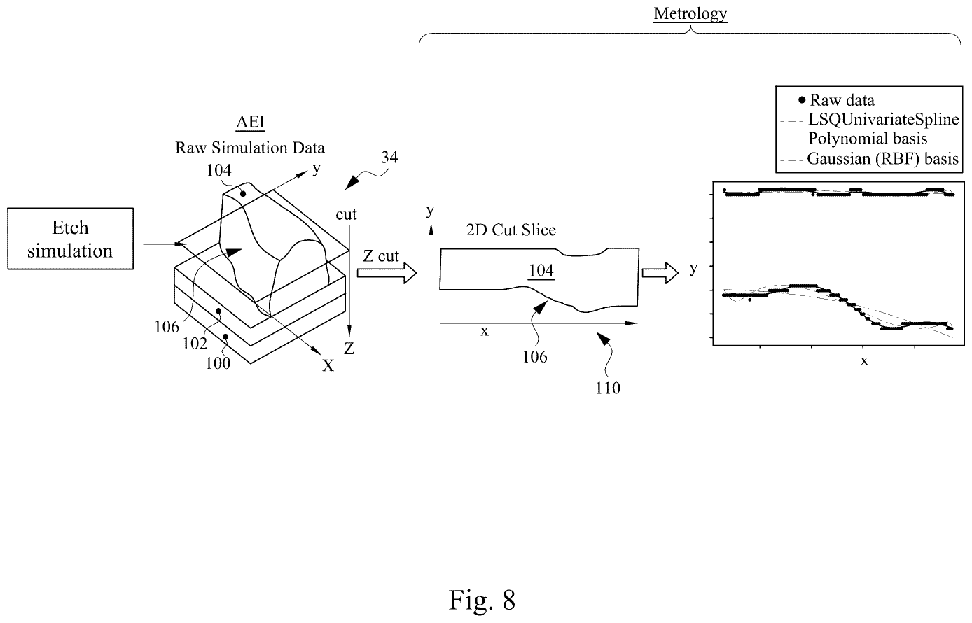

With reference to FIG. 8, a nonlimiting illustrative example of subsequent post-processing 36 (see FIG. 1) to extract metrology for the AEI contour 106 is diagrammatically shown. A two-dimensional (2D) cut 110 is extracted from the 3D AEI profile 34, where the cut 106 is an X-Y plane that is perpendicular to the Z-direction, as indicated in FIG. 8. This is a demonstration of one-dimensional (1D) line/strip etching. After rigorous etching simulation 28 to generate the 3D AEI profile 34, the in-plane cut 106 is taken at a chosen height of target layer to provides the 2D line contours. For better stability, the post-processing 36 may include applying a smoothing function to the 3D AEI profile 34 or to the extracted 2D cut 106, such as a least squared (LSQ) Univariate Spline, a polynomial smoothing function, or radial basis function (RBF) kernel smoothing, as some nonlimiting illustrative examples illustrated in the graph at the right-side of FIG. 8. Line edge roughness (LER) can be measured as the root-mean-square (RMS) of the smoothed edge. By performing Monte Carlo (MC) simulations using PMC-based approach 30, a distribution function (PDF) can be derived to benchmark LER of a patterning process.

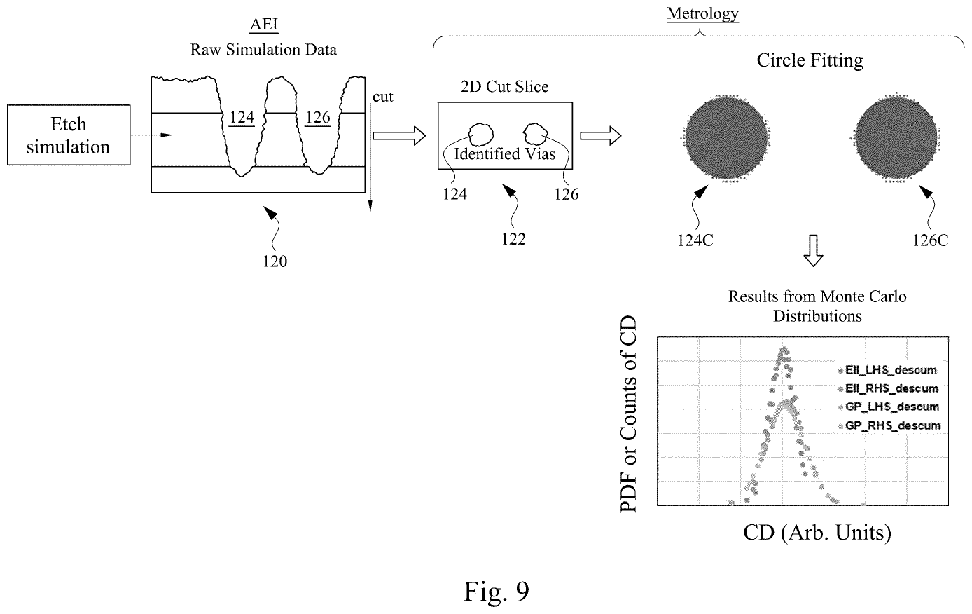

With reference to FIG. 9, another nonlimiting illustrative example of subsequent post-processing 36 (see FIG. 1) to extract metrology for the AEI structure is diagrammatically shown. This is an example of 2D via etching, and FIG. 9 diagrammatically shows two cuts 120 and 122 through a 3D AEI profile, which pass through via features 124 and 126. After the rigorous etching simulation 28 to generate the 3D AEI profile, the in-plane cutting 122 is taken at a selected height of target layer to provide the 2D via contours 124C and 126C for the respective etched vias 124 and 126. For better stability, a circle fitting routine can be used to extract via's center and critical dimension (CD). By performing Monte Carlo (MC) simulations using PMC-based approach, a distribution function (PDF) can be derived to benchmark edge-placement error (EPE) of a patterning process, as shown in the graph on the right side of FIG. 9.

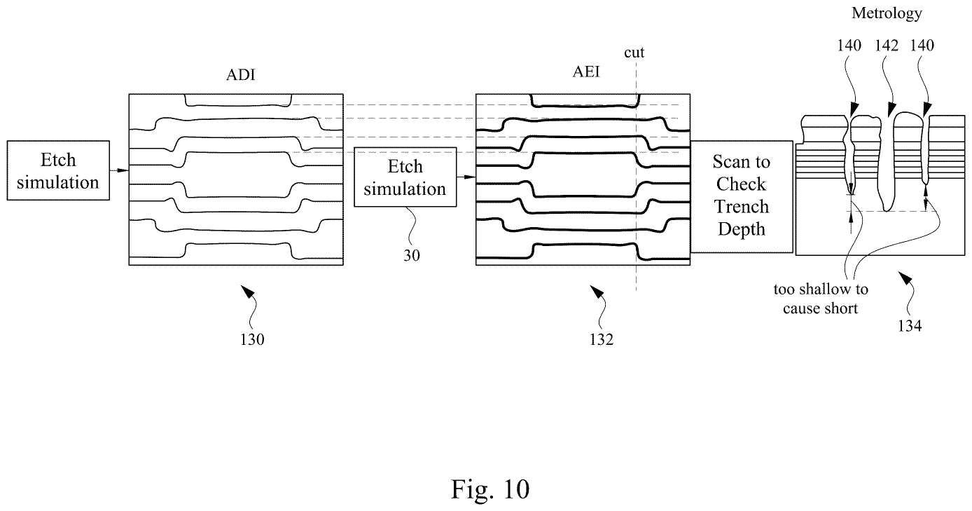

With reference to FIG. 10, another nonlimiting illustrative example of subsequent post-processing 36 (see FIG. 1) to extract metrology for the AEI structure is diagrammatically shown. This is an example of using a PMC etch simulation 30 to study micro-loading effects. Inputs are simulated 3D ADI profile 130 which patterns follow layout designs (masks). During the 3D PMC etch simulation 30, the effective etch rate depends on spacing or density of the patterns, which results in the etched amount (e.g. trench depth) also being sensitive to local patterns. This is seen in the metrology 134 of FIG. 10 in that outer patterns 140 are narrower and less deeply etched than a central pattern 142. The outer patterns 140 could be too shallow to cause a desired electrical contact (e.g., short) with an underlying conductive structure. The metrology 134 can be used to quantify defects and failure devices to further adjust the layout design rule employed for the pattern. For example, if a certain trench is less than allowed values, the corresponding spacing (width) is forbidden in layout design.

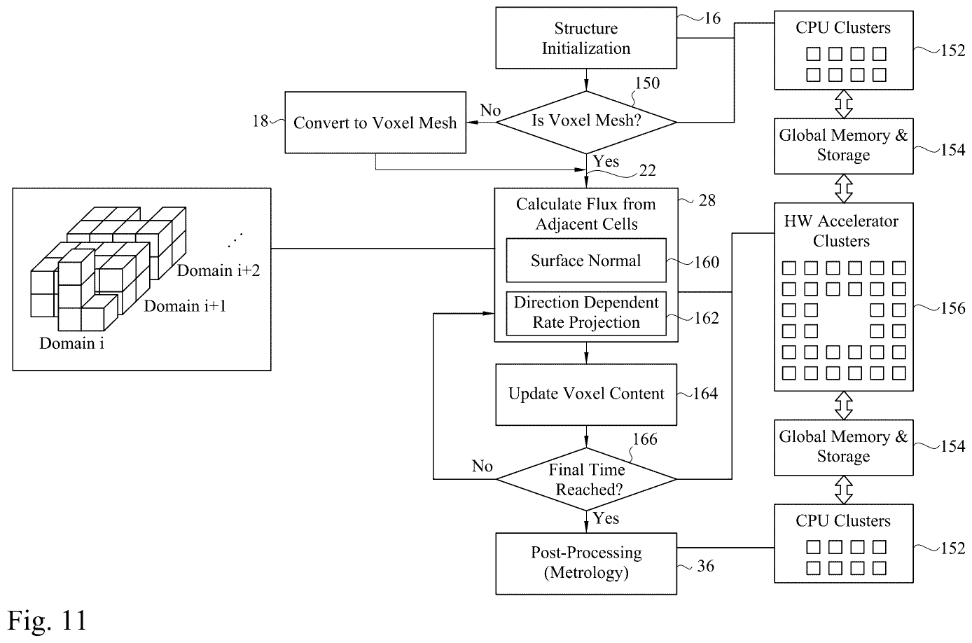

With reference now to FIG. 11, in some nonlimiting illustrative embodiments the etch simulation of process TCAD as disclosed herein is parallelized on hardware accelerators, such as GPUs. As already described with reference to FIG. 1, the 3D resist profile 16 is input, and if at decision 150 it is determined the input is not already a voxel mesh, then in an importation operation 18 the input 16 is converted to a voxel mesh to form the 3D ADI profile 22. This processing may be done by one or more CPU clusters 152 running CPU threads to import the structure 16 from external storage into memory 154, initialize process models, decompose and copy the structure segments and models into GPU-shared memory. During the etch simulation 28, GPUs or other hardware (HW) accelerator clusters 156 dynamically update the structure parts during set simulation time, e.g. using PMC and/or PE with parameters such as the surface normal 160 and simulating direction-dependent rate projections 162 to iteratively produce update voxel content 164. This is iteratively repeated until a stopping criterion 166 (e.g., time-based, total number of iterations limit, or the like) is met. Afterward, the completed 3D AEI profile is copied out into the memory 154 and sent to the CPU(s) 152 to synchronize and output, optionally including post-processing metrology 36. Note that in FIG. 11 the CPU(s) 152 and memory 154 are shown twice to facilitate depiction of data transfer flow. It is emphasized that the computing architecture diagrammatically shown in FIG. 11 is a nonlimiting illustrative example, and the etch simulation of the process TCAD as disclosed herein can be implemented in numerous computing architectures or infrastructures, such as CPU, GPU, FPGA, ASIC, heterogeneous, et cetera.

The etch simulation of process TCAD for simulating the ADI-to-AEI process as disclosed herein can be employed in numerous practical applications.

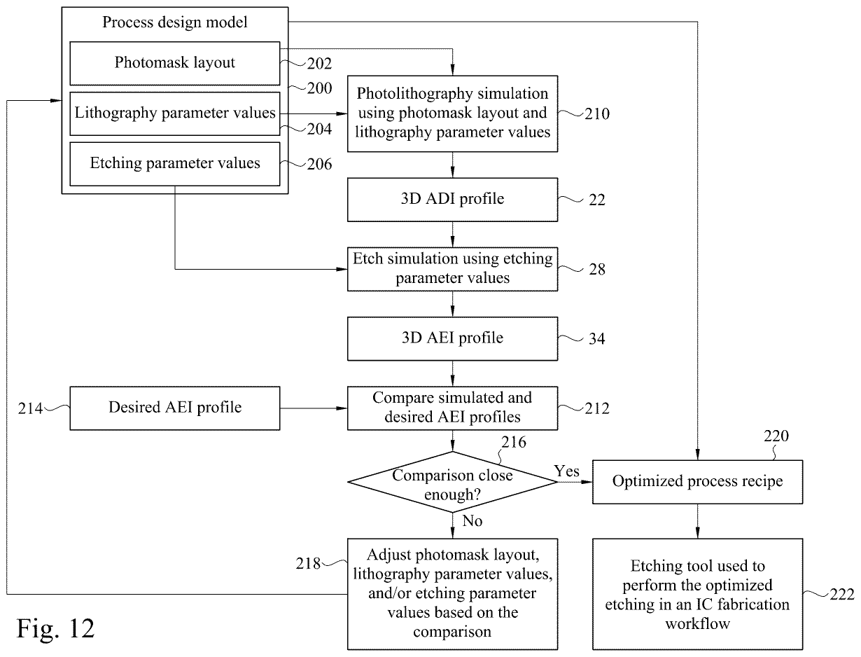

With reference to FIG. 12, the etch simulation of process TCAD as disclosed herein is utilized in this example to optimize an etch process recipe for use in fabrication of actual integrated circuit (IC) (or, more generally, an actual circuit layout). The input for this optimization is a process design model 200, including for example a photomask layout 202, lithography parameter values 204 (e.g., wavelength, optical power, photoresist and developer characteristics, et cetera), and etching parameter values 206. The photolithography wavelength may in general be in a visible light wavelength, an ultraviolet light wavelength, the deep ultraviolet (DUV) light wavelength, an extreme ultraviolet (EUV) light wavelength, or so forth, depending on the type of lithography. The etching parameter values 206 may include, for example, parameters of a chosen sputter yield model SPY(θ) selected from the examples of FIG. 6, as a nonlimiting illustrative example. In an operation 210, a photolithography simulation is performed using the photomask layout 202 and the lithography parameter values 204. The operation 210 can, for example, utilize optical ray tracing simulation along with the photoresist characteristics to simulate the latent image formed in the photoresist during the exposure, and can utilize the developer characteristics to simulate the openings formed in the photoresist layer in accordance with the latent image during the development process. The output of the operation 210 is the 3D ADI profile 22. (In some variant embodiments, this is provided as an input without performing the operation 210, e.g., as shown in FIG. 1). The etch simulation 28 is then performed as described herein, e.g., using the PMC etch simulation 30, the PE etch simulation 32, or a combination thereof, using the 3D ADI profile 22 as input. The etch simulation 28 further utilizes the etching parameter values 206 of the process design model 200, and outputs the 3D ADI profile 34.

With continuing reference to FIG. 12, in an operation 212 the 3D ADI profile 34 is compared with a desired AEI profile 214, which may be provided in various ways. For example, the desired AEI profile 214 could be generated from electron microscopy (e.g., TEM and/or SEM) images of an actual etched structure that the process design model 200 is being optimized to reproduce; or the desired AEI profile 214 could be produced by software modeling of a desired etched structure, as some nonlimiting illustrative examples. At a decision block 216 it is determined whether the simulated 3D AEI profile 34 is close enough to the desired AEI profile 214. If not, then flow passes to an operation 218 which adjusts the photomask layout 202, the lithography parameter values 204, and/or the etching parameter values 206 based on the comparison, and the processing 210, 28, 212, 216, 218 is repeated iteratively. The adjustment 218 can use any suitable optimization routine, such as a least squares optimization, a gradient descent method, or so forth. When (possibly after a number of iterations) the decision block 216 determines that the simulated 3D AEI profile 34 is close enough to the desired AEI profile 214, the final optimized process recipe 220 is output. The optimized process recipe comprises the optimized photomask layout 202, the optimized lithography parameter values 204, and/or the optimized etching parameter values 206 produced by the iterative optimization loop 210, 28, 212, 216, 218. The optimized process recipe 220 may serve as control parameters for controlling physical semiconductor fabrication equipment (i.e., tools) to perform the processing. For example, FIG. 12 shows the optimized process recipe 220 (or at least the optimized etching parameter values 206) being input to control an etching tool 222 (e.g., a plasma etching chamber 222, as a nonlimiting illustrative example) which is used to perform the optimized etching in an IC fabrication workflow.

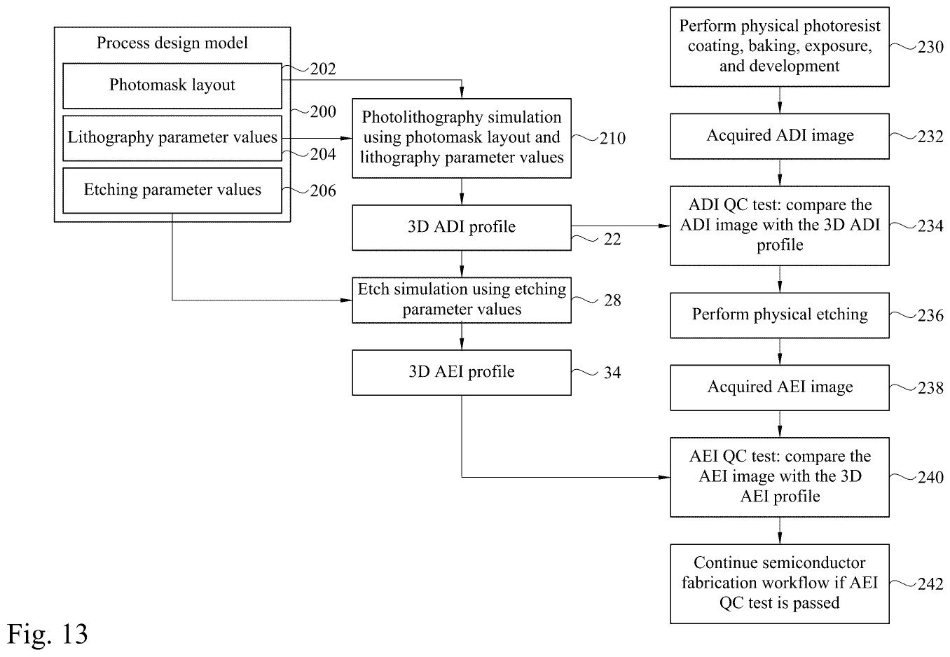

With reference to FIG. 13, the etch simulation of process TCAD as disclosed herein is utilized in this example to as a reference for performing after-etch inspection (AEI) quality control (QC) for an actually performed semiconductor processing workflow. In this QC example, the process design model 200 is again employed as input to the process TCAD. For QC, the process design model 200 may optionally have its parameters previously optimized in accordance with the method of FIG. 12. That is, for the QC of FIG. 13 the process design model 200 may include the optimized process recipe 220. More generally, for the QC of FIG. 13 the process design model 200 is optimized to represent the actual processing being performed in an actual IC semiconductor fabrication workflow. The QC of FIG. 13 also includes the operations 210 and 28 outputting the 3D ADI profile 22 and the 3D AEI profile 34 as previously described for FIG. 12.

In an operation 230, in the actually performed semiconductor processing workflow includes photolithography operations 230 comprising performing physical photoresist coating, baking (if required for the employed photoresist), photolithographic exposure to form the latent image in the photoresist, and development to form openings in the photoresist in accordance with the latent image. At least one ADI image 232 is acquired after performing the photolithography operations 230. For example, the ADI image 232 may be an SEM image, a TEM image, or a combination thereof. In an operation 234, an ADI QC test is performed by comparing the ADI image 232 with the 3D ADI profile 22. If the comparison is close enough, then the actually performed semiconductor processing workflow is continued by performing physical etching 236. (If the ADI QC test 234 is not passed, then the wafer may be scrapped, and/or the fabrication facility may perform diagnostics to determine why the photolithographic processing 230 failed). The etching 236 may, for example, form a circuit layout.

At least one AEI image 238 is acquired after performing the etching 236. For example, the acquired AEI image 238 may be an SEM image, a TEM image, or a combination thereof. In an operation 240, an AEI QC test is performed by comparing the acquired AEI image 238 with the 3D AEI profile 34. If the comparison is close enough (for example, based on comparison of the quantitative metrology generated by post-processing 36, see FIG. 1) then the actually performed semiconductor processing workflow is continued as indicated by operation 242. (If the AEI QC test 240 is not passed, then the wafer may be scrapped, and/or the fabrication facility may perform diagnostics to determine why the etching 236 failed).

The applications described with reference to FIGS. 12 and 13 are merely nonlimiting illustrative examples—the etch simulation of process TCAD as disclosed herein may be utilized in numerous other applications.

In some further examples described hereinbelow, process TCAD simulation of etching (and/or, in other nonlimiting illustrative examples, ion implantation) incorporates photoresist and/or hard mask trimming. In this workflow, after patterning, plasma etching is performed to reduce the dimensions of the pattern, a step referred to as trimming.

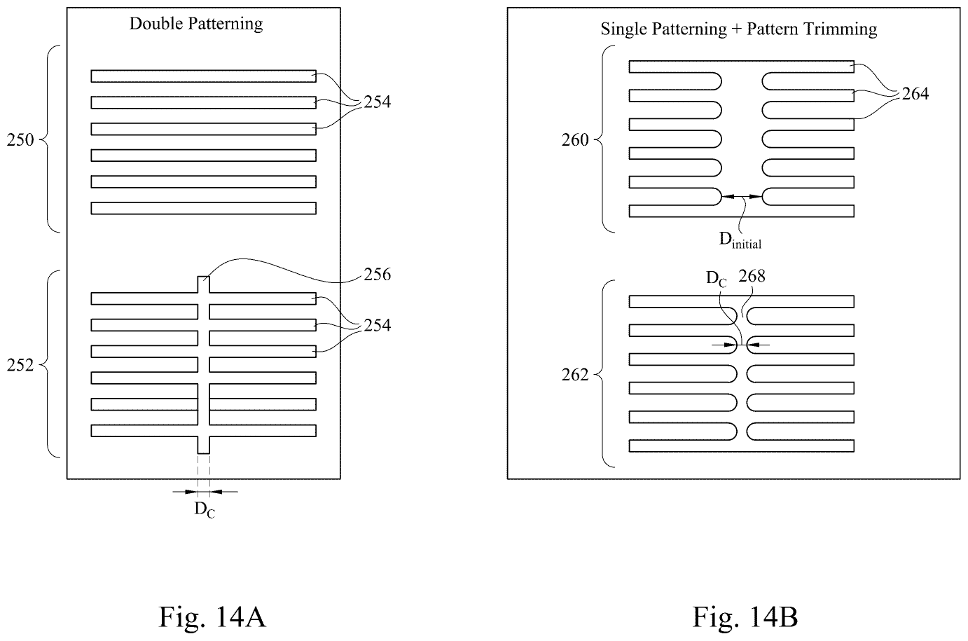

With reference now to FIGS. 14A, an approach is described for achieving a small critical dimension D_{C} without using trimming. This approach uses two photolithographically defined patterning steps 250 and 252. In the first photolithographically defined patterning step 250, mutually parallel linear features 254 are formed. In the second photolithographically defined patterning step 252, a linear feature 256 with critical dimension D_{C} is formed, which is oriented transverse to and crossing the mutually parallel linear features 254. The approach of FIG. 14A thus entails two patterning steps 250 and 252. To obtain a small critical dimension D_{C}, these two patterning steps 250 and 252 may be extreme ultraviolet (EUV) photolithography steps, which are costly in terms of workflow time on the EUV scanner.

With reference now to FIGS. 14B, an approach is described for achieving the small critical dimension D_{C} using trimming. This approach uses only a single photolithographically defined patterning step 260, which forms both mutually parallel linear features 264 (corresponding to the mutually parallel linear features 254 of the example of FIG. 14A) and a transverse linear feature 268 which is oriented transverse to and crosses the mutually parallel linear features 264. The transverse linear feature 268 corresponds to the transverse linear feature 256 of FIG. 14A, but has a larger critical dimension Dᵢₙᵢₜᵢₐₗ (that is, Dᵢₙᵢₜᵢₐₗ>D_{C}). After the photolithographically defined patterning step 260, a trimming step 262 is performed, which employs plasma etching to reduce the dimensions of the transverse linear feature 266 to produce a trimmed transverse linear feature 268 with the critical dimension D_{C}. The approach of FIG. 14B thus entails a single patterning step 260, which advantageously reduces time on the EUV scanner while still maintaining feature density (captured by the small critical dimension D_{C}).

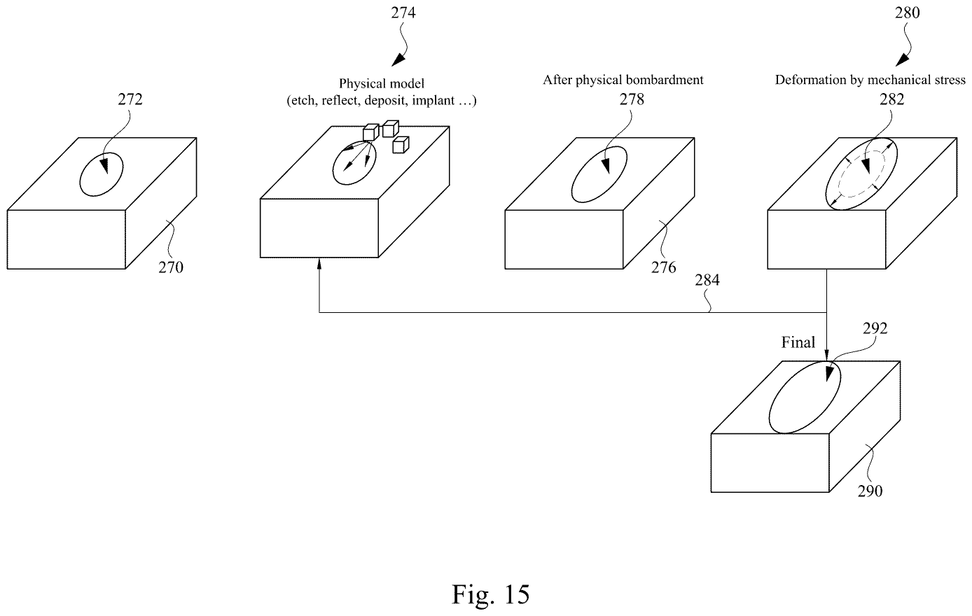

With reference to FIG. 15, the disclosed approaches of simulating a 3D AEI profile by simulating etching of the semiconductor structure using an iterative 3D physical etch simulation is extendible to accurate simulation of trimming. To do so, mechanical deformation due to mechanical stress during the trimming process is also modeled. In the diagrammatic example of FIG. 15, a starting semiconductor structure 270 (for example, corresponding to the semiconductor structure 50 represented by a 3D ADI profile 22 as previously described) includes an opening 272, for example formed by photolithographic etching. In a simulated operation 274, an ion beam treatment is applied. The ion beam treatment 274 may perform trimming, ion implantation, material deposition, or so forth. The resulting simulated semiconductor structure 276 includes a modified opening 278 which (in this example) is enlarged compared with the original opening 272. The ion treatment simulation 274 may, for example, employ Particle Monte Carlo (PMC) simulation as previously described with reference to FIGS. 4A and 4B. although other approaches for simulating physical etching are contemplated, such as process emulation (PE, previously described with reference to FIG. 5).

However, the PMC (or other) ion treatment simulation 274 does not account for mechanical deformation, such as may occur due to various causes. For example, heating and/or stress relaxation during the ion treatment 274 may produce softening or reflow of the photoresist (and/or of the hard mask, if used). The mechanical deformation can occur three-dimensionally, with impact on the height (i.e., thickness) and width of the structure undergoing mechanical deformation. For example, mechanical deformation can produce shrinkage of both the height and lateral dimensions of a patterned photoresist layer. To account for mechanical deformation, the simulation of FIG. 15 further simulates the mechanical deformation (described further hereinbelow) in a step 280. If the simulated mechanical deformation causes shrinkage, then this results in an enlarged opening 282 after the mechanical deformation simulation 280 that is larger than the opening 278 simulated by the PMC (or other) etch simulation 274. Since the mechanical deformation occurs over time during the ion treatment, the simulation steps 274 (ion treatment) and 280 (mechanical deformation) may be repeated iteratively, as diagrammatically indicated in FIG. 15 by arrow 284. Viewed another way, the ion treatment 274 and the mechanical deformation 280 are simulated in a time-shared manner. After the final iteration, a final semiconductor structure 290 is produced, with a final simulated opening 292 that accounts for both the ion treatment 274 and the mechanical deformation 280.

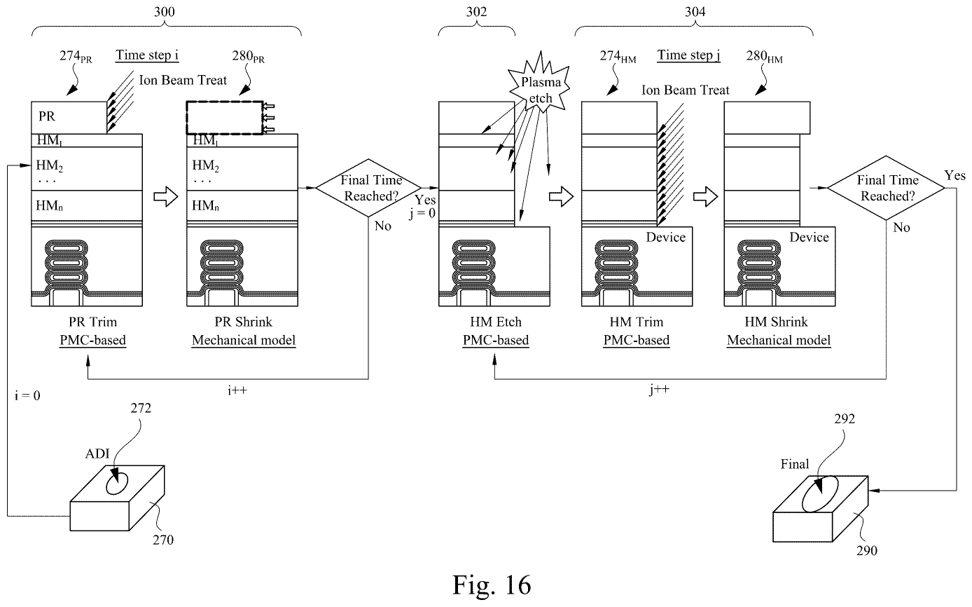

With reference now to FIG. 16, another example of simulating the 3D AEI profile 290 by simulating etching of the semiconductor structure including trimming with concurrent mechanical deformation using an iterative 3D simulation is described. Again, time-shared iterative simulation of the ion treatment and mechanical deformation is employed. Prior to the processing shown in FIG. 16, the semiconductor structure is coated with photoresist, optically exposed through a photolithography mask to form a latent image in and/or on the photoresist coating, and the latent image developed to form the patterned photoresist layer PR with openings in the photoresist. In this example, the patterned photoresist is then trimmed in a first trimming step 300 which is performed after the patterning a photoresist layer PR. This is followed by a hard mask patterning step 302 in which the hard mask (in the illustrative example including multiple hard mask layers HM₁, HM₂, . . . , HMₙ) is patterned by plasma etching using the patterned photoresist to define the hard mask pattern. Finally, a second trimming step 304 is performed in which the patterned hard mask is trimmed. The simulation of the photoresist trimming 300 includes iterative PMC (or other) simulation of the ion treatment 274_{PR} followed by mechanical deformation simulation 280_{PR}. Without loss of generality, these iterations are indexed by an index time step i in FIG. 16. The simulation of the hard mask trimming 304 includes iterative PMC (or other) simulation of the ion treatment 274_{HM} followed by mechanical deformation simulation 280_{HM}. Without loss of generality, these iterations are indexed by an index time step j in FIG. 16. The last iteration of the hard mask trimming 304 produces the final structure 290 with final opening 292, as previously described with reference to FIG. 15.

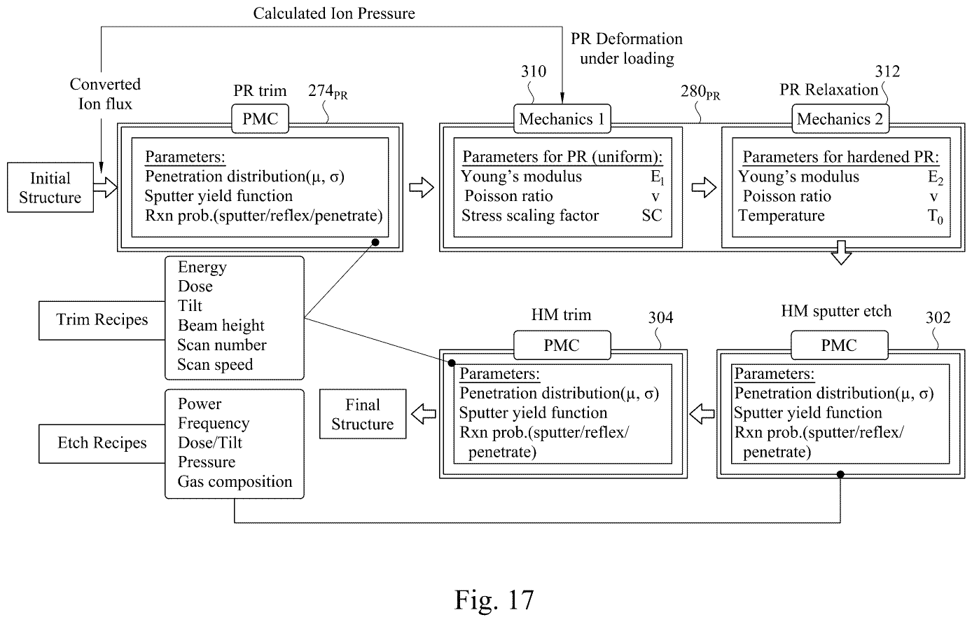

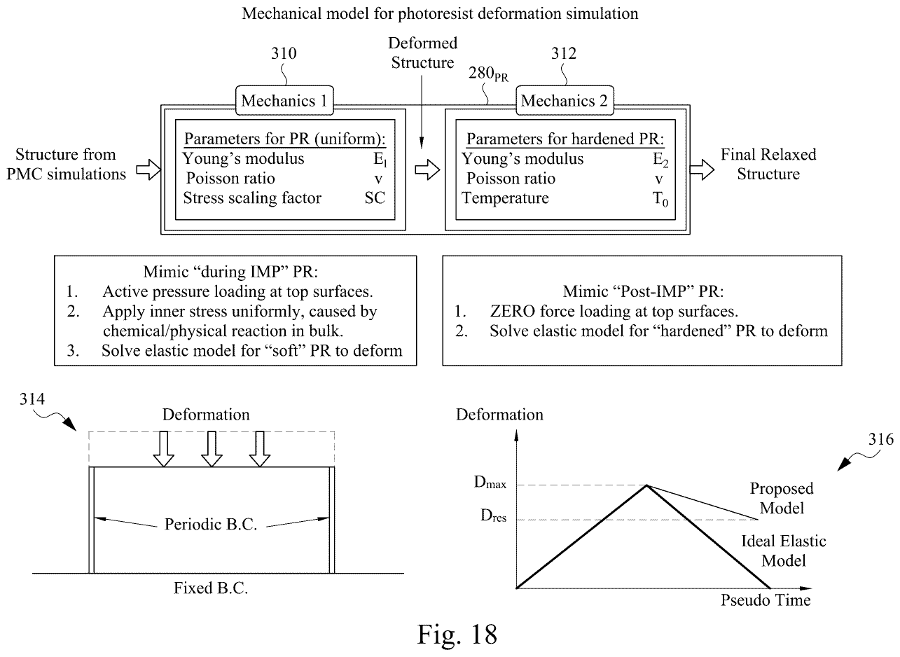

FIG. 17 diagrammatically illustrates a nonlimiting illustrative example of parameters used in an example of the TCAD simulation of FIG. 16. In the example of FIG. 17, the second trimming step 304 in which the patterned hard mask is trimmed does not include the mechanical deformation simulation 280_{HM} of the example of FIG. 16, which can be an appropriate omission if, for example, the hard mask material is not prone to significant mechanical deformation. As seen in FIG. 17, the PMC simulation 274_{PR} of the photoresist trimming includes trim recipe parameters (e.g., energy, dose, beam angle tilt, beam height, scan number and speed) and further includes parameters such as the penetration distribution (e.g., represented by distribution mean u and standard deviation σ), sputter yield function, and reaction (Rxn) probabilities for reactions such as sputtering 68, reflection 70, and penetration (i.e., implantation) 66 (see FIGS. 4A and 4B). These are suitable inputs to the PMC simulation of FIG. 4A. The photoresist deformation simulation 280_{PR} is described in further detail hereinbelow with reference to FIG. 18. The sputter etch simulation 302 of the hard mask etching receives trim recipe parameters (e.g., power, frequency, dose/tilt, pressure, gas composition) and further parameters such as the penetration distribution (e.g., represented by μ and σ), sputter yield function, and reaction (Rxn) probabilities for reactions such as sputtering 68, reflection 70, and penetration (i.e., implantation) 66. These are suitable inputs to the PMC simulation of FIG. 4A. The hard mask trimming simulation 304 (which in this example omits the mechanical deformation 280_{HM}) includes trim recipe parameters (e.g., energy, dose, beam angle tilt, beam height, scan number and speed) and further includes parameters such as the penetration distribution (e.g., represented by μ and σ), sputter yield function, and reaction (Rxn) probabilities for reactions such as sputtering 68, reflection 70, and penetration (i.e., implantation) 66. These are suitable inputs to the PMC simulation of FIG. 4A.

With reference now to FIG. 18, the photoresist mechanical deformation simulation 280_{PR} of FIG. 17 is diagrammatically shown in accordance with one nonlimiting illustrative embodiment. The illustrative photoresist mechanical deformation simulation 280_{PR} is implemented as a first stage 310 which models the deformation during the ion implantation, and a second stage 312 which models the deformation post-implantation. The “during implantation” simulation 310 receives as inputs mechanical properties of the photoresist material such as Young's modulus (E₁), the Poisson ratio (v), and the stress scaling factor (SC). The “during implantation” simulation 310 models the active pressure loading at top surfaces due to the influx of ions (diagrammatically indicated by a plot 314 at bottom left of FIG. 18), and applies inner stress uniformly caused by chemical and/or physical reaction in the bulk. The “during implantation” simulation 310 may, for example, model the mechanical deformation of the photoresist using an elastic model for soft photoresist (that is, photoresist which has not been hardened by exposure to the ion beam).

The “post-implantation” simulation 312 receives as inputs mechanical properties of the photoresist material hardened by the ion implantation, such as Young's modulus (E₂), the Poisson ratio (v), and the stress scaling factor (SC). The “post-implantation” simulation 312 may, for example, model the mechanical deformation of the photoresist assuming zero force loading at the top surfaces, and may again use an elastic model, but this time for the hardened photoresist (that is, the photoresist after having been hardened by exposure to the ion beam).

A plot 316 at the lower right of FIG. 18 shows two nonlimiting examples of deformation models plotting deformation (D) as a function of time (represented as “Pseudo Time” by time steps indexed by i for example). The ideal elastic model may be used for the “during implantation” simulation 310, while the “Proposed Model” may be used for the “post-implantation” simulation 312. These are merely nonlimiting illustrative examples, and other mechanical deformation models can be employed, such as nonlinear deformation models.

The mechanical deformation model of FIG. 18 includes both the “during implantation” simulation 310 which models deformation during the ion implantation based on mechanical parameters of the “soft” photoresist or hard mask (that is, photoresist or hard mask which has not been hardened by exposure to the ion beam), and “post-implantation” simulation 310 which models deformation after the ion implantation based on mechanical parameters of the photoresist or hard mask material after hardening by the ion implantation. However, it is contemplated in some variant embodiments to include only the “during implantation” simulation 310. It is also contemplated in some variant embodiments to include only the “post-implantation” simulation 312. Omission of one of these simulations 310 or 312 might be appropriate if, for example, the change in mechanical parameters due to the hardening by the ion implantation means that the amount of shrinkage (or other mechanical deformation) of the omitted simulation is negligible compared with the other simulation. Put another way, the mechanical deformation of the patterned layer may be modeled during the trimming (via simulation 310) and/or after the trimming (via simulation 312).

It will be appreciated that simulation of trimming, optionally including simulation of mechanical deformation, may be incorporated into the etch simulation 28 of the process TCAD system 10 of FIG. 1 or the etch simulation of process TCAD described with reference to FIG. 12, or the etch simulation of process TCAD described with reference to FIG. 13, or more generally into other etch simulations, in order to advantageously accurately model patterning of photoresist and/or hard mask layers which includes a trimming step. Moreover, while in the illustrative examples the patterned layer that is trimmed is a patterned photoresist layer or a patterned hard mask layer, more generally the trimming could be applied to any patterned layer of the semiconductor structure, in order to achieve a smaller critical dimension for that patterned layer.

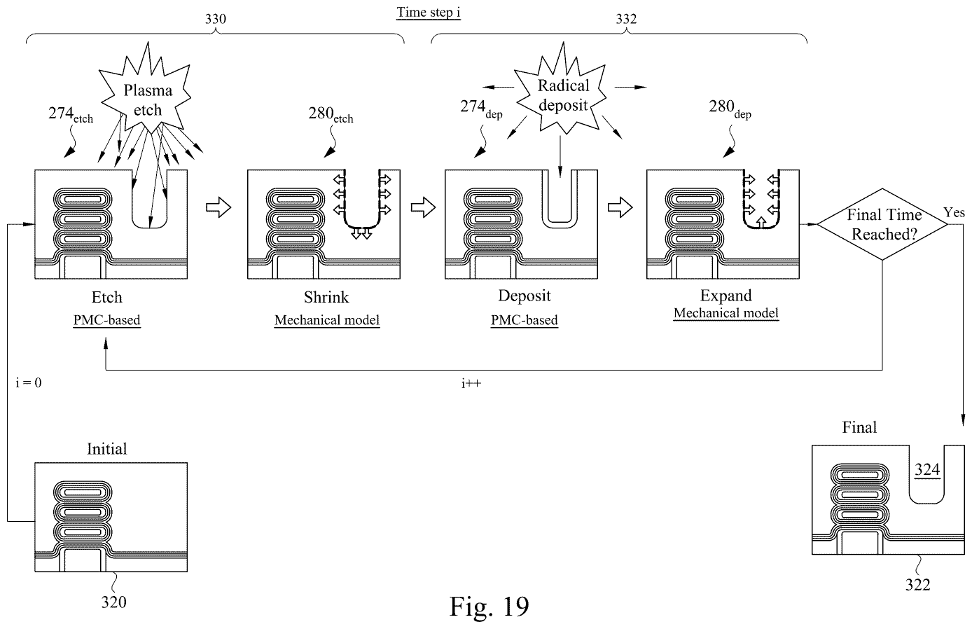

With reference to FIG. 19, in another example, process TCAD is used to simulate an etch process in a time-shared manner. Here, a portion of initial semiconductor structure 320 is etched to form a final semiconductor structure 322 with an etched opening 324. In this process, plasma etching results in concurrent deposition of ions on the surface of the opening being etched and/or in the surface region of the opening (i.e., ion implantation into the surface region), and both the etching and the deposition/ion implantation induce mechanical deformation, e.g., by stress relaxation. These processes occur concurrently: etching; deposition/ion implantation; and mechanical deformation. In the example of FIG. 19, these concurrent mechanisms are simulated in a two-part time-shared simulation. In a first part 330, a PMC (or other) simulation 274_{etch} of plasma etching is followed by a mechanical deformation simulation 280_{etch} accounting for mechanical deformation due to the etching. In a second part 332, a PMC (or other) simulation 274_{dep} of the deposition and/or ion implantation is followed by a mechanical deformation simulation 280_{dep} accounting for mechanical deformation due to the deposition and/or ion implantation. The plasma etching is a form of ion treatment, and so the plasma etching simulation 274_{etch} suitably employs PMC or another physical etching simulation such as PE. Likewise, the deposition and/or ion implantation 274_{dep} is also a form of ion treatment that suitably employs PMC or another physical etching simulation such as PE. As indicated by flowback arrow 334, the sequence of simulations 274_{etch}, 280_{etch}, 274_{dep}, and 280_{dep} are repeated for time increments i up to a final time.

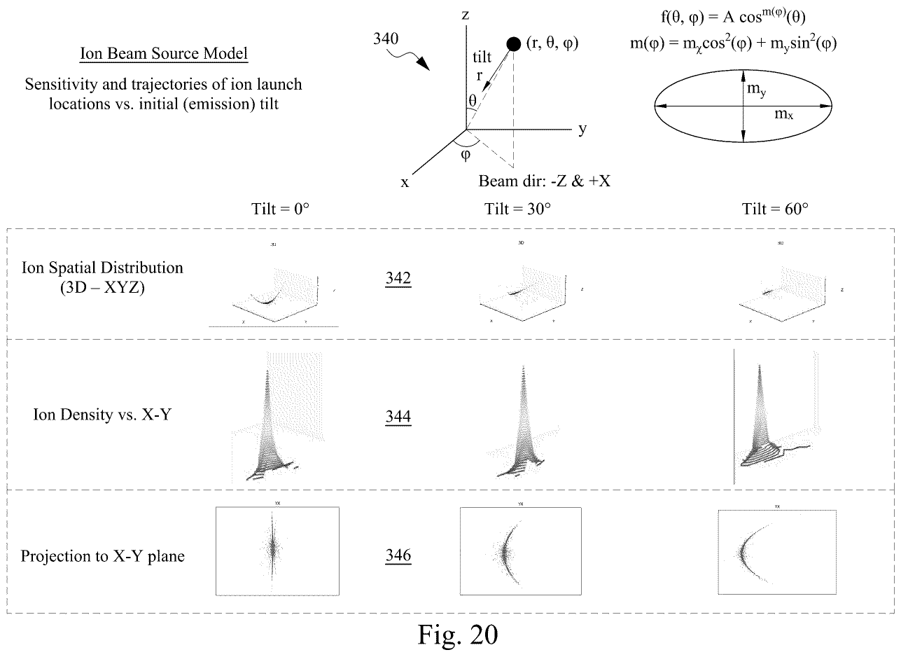

With reference to FIG. 20, simulations are shown of an ion beam source model suitably used in the process TCAD simulations of ion treatments for photoresist trimming, hard mask trimming, and the like. The simulations provide information on the sensitivity and trajectories of ion launch locations versus initial emission tilt angle. FIG. 20 shows simulation results for an ion beam model 340 with tilt angles of 0 degrees, 30 degrees, and 60 degrees. The results are shown as ion spatial distribution in 3D in the Cartesian X-Y-Z space 342, ion density in the X-Y plane 344, and a projection view to the X-Y plane 346.

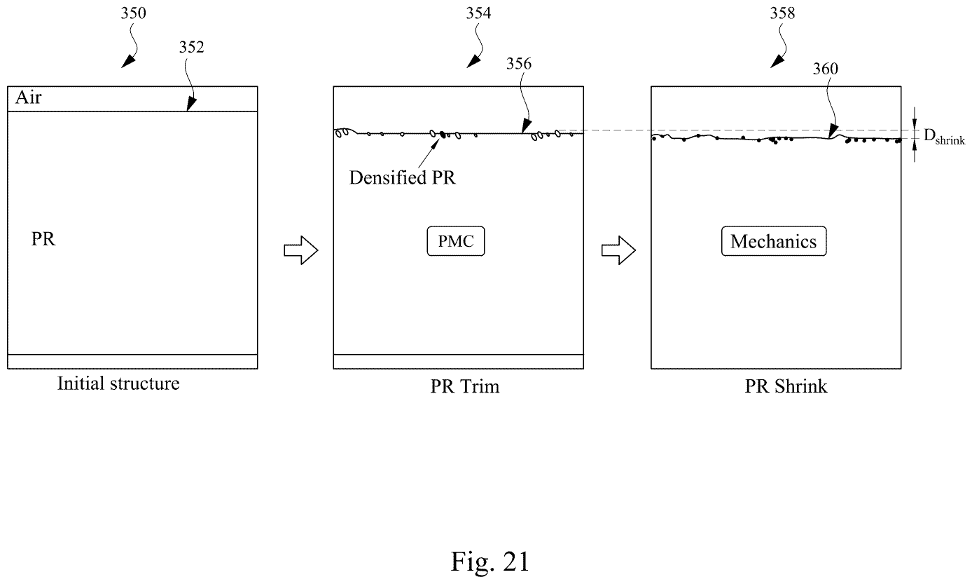

With reference to FIG. 21, a nonlimiting illustrative example is shown of simulation of trimming of a blanket layer of photoresist including mechanical deformation. An initial structure 350 includes a blanket layer of photoresist (PR) and overlying air. An air/photoresist interface 352 is planar prior to the trimming in this example simulation. A structure 354 depicts the result after simulation of trimming by applying an ion beam treatment, where the ion beam treatment is simulated in accordance with the PMC etch simulation of FIG. 4A, including etching 68, reflection 70, and deposition/implantation 66. The trimming modifies the initial planar air/photoresist interface 352 to produce a densified surface 356. The resulting mechanical deformation is simulated using the approach described with reference to FIG. 18 to produce an air/photoresist interface 360 which has shrunk (i.e., the overall thickness of the photoresist has been reduced) by a shrinkage distance Dₛₕᵣᵢₙₖ. While trimming is typically applied to a patterned photoresist (or hard mask), the example of FIG. 21 illustrates that such trimming affects (e.g., reduces) the vertical (or height) dimension as well as trimming the lateral dimensions of a patterned photoresist.

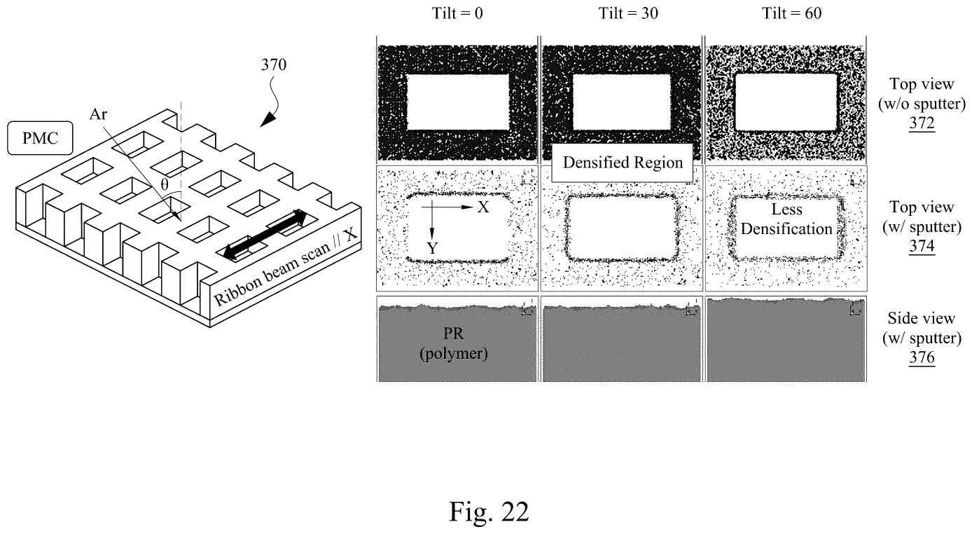

FIG. 22 diagrammatically illustrates a nonlimiting illustrative example of simulation of trimming of patterned photoresist including mechanical deformation, for an argon ion beam (Art) modeled for the three ion beam tilt angles (0 degrees; 30 degrees; and 60 degrees) of FIG. 20. These examples do not include mechanical deformation modeling, but rather illustrate varying densification levels under the different modeled ion source tilt conditions following the PMC simulation of the ion beam treatment according to the PMC etch simulation of FIG. 4A (with etching 68, reflection 70, and implantation 66 effects). FIG. 22 shows the initial structure 370 in perspective view, along with: top views 372 for the result of the PMC etch simulation using the modeling of FIG. 4A but without including sputter etching; top views 374 and side views 376 for the result of the PMC etch simulation using the modeling of FIG. 4A including sputter etching. As seen, employing the largest tilt angle of 60 degrees produces the least amount of surface densification. This is merely one nonlimiting illustrative example of how the process TCAD modeling disclosed herein can be usefully applied to optimize process parameters (here, the ion beam tilt angle used in photoresist trimming).

In the following, some further embodiments are described.

In a nonlimiting illustrative embodiment, a non-transitory storage medium stores instructions readable and executable by an electronic processor to perform a process technology computer-aided design (TCAD) method comprising: generating a simulated three-dimensional after etch inspection (AEI) profile by simulating etching of a semiconductor structure represented by a three-dimensional after-development inspection (ADI) profile using an iterative three-dimensional physical etch simulation; and comparing the simulated three-dimensional AEI profile with a desired AEI profile or with an acquired AEI image.

In a nonlimiting illustrative embodiment, a method is disclosed of processing a semiconductor structure. The method comprises: coating photoresist on a semiconductor substrate to form a photoresist layer; exposing the photoresist layer to form a partially exposed photoresist layer; developing the partially exposed photoresist layer to form a patterned photoresist layer; trimming the patterned photoresist layer to produce a trimmed patterned photoresist layer; etching the substrate through the trimmed patterned photoresist layer to form a circuit layout; acquiring an after etch inspection (AEI) image of the semiconductor structure after the etching; generating a simulated three-dimensional AEI profile by simulating the trimming and the etching applied to a three-dimensional after-development inspection (ADI) profile representing the semiconductor structure after the coating, exposing, and developing, wherein the simulation of the etching uses an iterative three-dimensional physical etch simulation; comparing the simulated three-dimensional AEI profile and the acquired AEI image; and performing further processing of the semiconductor structure based on the comparison indicating the semiconductor structure after the performed etching satisfies a quality control acceptance criterion.

In a nonlimiting illustrative embodiment, a process technology computer-aided design (TCAD) system comprises a computer programmed to perform a process TCAD method including: generating a simulated three-dimensional after etch inspection (AEI) profile by simulating etching of a three-dimensional after-development inspection (ADI) profile of a semiconductor structure after processing by a photolithographic processing sequence, the simulated etching being performed using an iterative three-dimensional physical etch simulation; comparing the simulated three-dimensional AEI profile with a desired AEI profile; adjusting the photolithographic processing sequence and/or a physical etch simulated by the iterative three-dimensional physical etch simulation based on the comparison of the simulated three-dimensional AEI profile with the desired AEI profile; and repeating the simulating of the etching, the comparing, and the adjusting until the comparison of the simulated three-dimensional AEI profile with the desired AEI profile indicates the simulated three-dimensional AEI profile is acceptable.

In a nonlimiting illustrative process technology computer-aided design, a simulated three-dimensional after etch inspection (AEI) profile is generated by simulating etching of a semiconductor structure represented by a three-dimensional after-development inspection (ADI) profile using an iterative three-dimensional physical etch simulation. The simulated three-dimensional AEI profile is compared with a desired AEI profile or with an acquired AEI image. The iterative three-dimensional physical etch simulation may be a Particle Monte Carlo (PMC) etch simulation. The iterative three-dimensional physical etch simulation may be a Process Emulation (PE) etch simulation. The generating of the simulated three-dimensional AEI profile may further include simulating trimming of a patterned layer of the semiconductor structure performed by applying an ion beam treatment to the patterned layer. The simulation of the trimming may include modeling mechanical deformation of the patterned layer during and/or after the trimming.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A non-transitory storage medium storing instructions readable and executable by an electronic processor to perform a process technology computer-aided design (TCAD) method comprising:
generating a simulated three-dimensional after etch inspection (AEI) profile by simulating etching of a semiconductor structure represented by a three-dimensional after-development inspection (ADI) profile using an iterative three-dimensional physical etch simulation; and
comparing the simulated three-dimensional AEI profile with a desired AEI profile or with an acquired AEI image.

2. The non-transitory storage medium of claim 1, wherein the iterative three-dimensional physical etch simulation comprises:
Monte Carlo sampling of three-dimensional trajectories of electrically charged particles sputter etching the three-dimensional ADI profile.

3. The non-transitory storage medium of claim 2, wherein the Monte Carlo sampling further includes Monte Carlo sampling of deposition and reflection reactions of the electrically charged particles with the three-dimensional ADI profile.

4. The non-transitory storage medium of claim 2, wherein the Monte Carlo sampling further includes computing sputter yields of the electrically charged particles using a sputter yield model that is functionally dependent on an angle of the three-dimensional trajectories of the electrically charged particles.

5. The non-transitory storage medium of claim 1, wherein the iterative three-dimensional physical etch simulation comprises an iterative three-dimensional etch process emulation.

6. The non-transitory storage medium of claim 5, wherein the iterative three-dimensional etch process emulation computes a volume parameter φ_{i,j,k} as a function of three-dimensional voxel location (i, j, k) using a Hamilton-Jacobi equation given by:
$$\frac{\partial φ}{\partial t} + H ( ∇ φ ) = 0$$
where ∇φ is a gradient of the volume parameter φ_{i,j,k} and
$$\frac{\partial φ}{\partial t}$$
is a partial derivative of the volume parameter φ_{i,j,k} with respect to time t.

7. The non-transitory storage medium of claim 1, wherein the generating of the simulated three-dimensional AEI profile further includes simulating trimming of a patterned layer of the semiconductor structure, the trimming being performed by applying an ion beam treatment to the patterned layer.

8. The non-transitory storage medium of claim 7, wherein the simulating of the trimming includes modeling mechanical deformation of the patterned layer during and/or after the trimming.

9. The non-transitory storage medium of claim 1, further comprising:
generating the three-dimensional ADI profile by modeling a photolithographic processing sequence including coating the semiconductor structure with a photoresist coating, optical exposure of the photoresist coating, and development of the photoresist coating after the optical exposure, wherein the comparing comprises comparing the simulated three-dimensional AEI profile with a desired AEI profile, and the process TCAD method further comprises:
adjusting one or more parameters of the photolithography processing sequence and/or of the iterative three-dimensional physical etch simulation based on the comparison of the simulated three-dimensional AEI profile with the desired AEI profile; and
repeating the producing the three-dimensional ADI profile, the simulating of the etching, the comparing, and the adjusting until the comparison of the simulated three-dimensional AEI profile with the desired AEI profile indicates the simulated three-dimensional AEI profile is acceptable.

10. The non-transitory storage medium of claim 1, wherein the process TCAD method further comprises:
producing the three-dimensional ADI profile using at least one electron microscopy image of the semiconductor structure after photolithographic processing including photoresist coating of the semiconductor structure, optical exposure of the photoresist coating, and development of the photoresist coating after the optical exposure.

11. The non-transitory storage medium of claim 1, wherein the comparing comprises comparing the simulated three-dimensional AEI profile with an AEI image acquired of a semiconductor wafer that has undergone photolithographic processing and etching, and the process TCAD method further comprises:
outputting an indication of whether the semiconductor wafer satisfies a quality control acceptance criterion based on the comparison.

12. A method of processing a semiconductor structure, the method comprising:
coating photoresist on a semiconductor substrate to form a photoresist layer;
exposing the photoresist layer to form a partially exposed photoresist layer;
developing the partially exposed photoresist layer to form a patterned photoresist layer;
trimming the patterned photoresist layer to produce a trimmed patterned photoresist layer;
etching the substrate through the trimmed patterned photoresist layer to form a circuit layout;
acquiring an after etch inspection (AEI) image of the semiconductor structure after the etching;
generating a simulated three-dimensional AEI profile by simulating the trimming and the etching applied to a three-dimensional after-development inspection (ADI) profile representing the semiconductor structure after the coating, exposing, and developing, wherein the simulation of the etching uses an iterative three-dimensional physical etch simulation;
comparing the simulated three-dimensional AEI profile and the acquired AEI image; and
performing further processing of the semiconductor structure based on the comparison indicating the semiconductor structure after the performed etching satisfies a quality control acceptance criterion.

13. The method of claim 12, wherein the iterative three-dimensional physical etch simulation comprises:
Monte Carlo sampling of three-dimensional trajectories of electrically charged particles sputter etching the three-dimensional ADI profile and computation of sputter yields of the electrically charged particles using a sputter yield model that is functionally dependent on an angle of the three-dimensional trajectories of the electrically charged particles.

14. The method of claim 12, wherein the iterative three-dimensional physical etch simulation comprises an iterative three-dimensional etch process emulation that computes a volume parameter φ_{i,j,k} as a function of three-dimensional voxel location (i, j, k) using a Hamilton-Jacobi equation given by:
$$\frac{\partial φ}{\partial t} + H ( ∇ φ ) = 0$$
where ∇φ is a gradient of the volume parameter φ_{i,j,k} and
$$\frac{\partial φ}{\partial t}$$
is a partial derivative of the volume parameter φ_{i,j,k} with respect to time t.

15. The method of claim 12, wherein the comparing the simulated three-dimensional AEI profile and the acquired AEI image includes fitting at least one edge of the simulated three-dimensional AEI profile with a parametric shape or line.

16. The method of claim 12, wherein the simulating of the trimming includes performing an iterative process in which each iteration includes:
simulation of the ion beam treatment applied to the patterned photoresist using Monte Carlo sampling of three-dimensional trajectories of ions of the ion beam treatment; and
simulation of mechanical deformation of the patterned photoresist using a mechanical deformation model.

17. A process technology computer-aided design (TCAD) system comprising:
a computer programmed to perform a process TCAD method including:
generating a simulated three-dimensional after etch inspection (AEI) profile by simulating etching of a three-dimensional after-development inspection (ADI) profile of a semiconductor structure after processing by a photolithographic processing sequence, the simulated etching being performed using an iterative three-dimensional physical etch simulation;
comparing the simulated three-dimensional AEI profile with a desired AEI profile;
adjusting the photolithographic processing sequence and/or a physical etch simulated by the iterative three-dimensional physical etch simulation based on the comparison of the simulated three-dimensional AEI profile with the desired AEI profile; and
repeating the simulating of the etching, the comparing, and the adjusting until the comparison of the simulated three-dimensional AEI profile with the desired AEI profile indicates the simulated three-dimensional AEI profile is acceptable.

18. The process TCAD system of claim 17, wherein the iterative three-dimensional physical etch simulation comprises Monte Carlo sampling of three-dimensional trajectories of electrically charged particles sputter etching the three-dimensional ADI profile.

19. The process TCAD system of claim 17, wherein the iterative three-dimensional physical etch simulation comprises an iterative three-dimensional etch process emulation which solves a Hamilton-Jacobi equation for volume parameters φ_{i,j,k} as a function of three-dimensional voxel location (i, j, k).

20. The process TCAD system of claim 17, wherein the generating of the simulated three-dimensional AEI profile further includes:
simulating trimming of a patterned photoresist layer of the ADI profile prior to the simulation of the etching, wherein the simulating of the trimming includes:
simulating an ion beam treatment applied to the patterned photoresist layer using Monte Carlo sampling of three-dimensional trajectories of ions of the ion beam treatment; and
simulating mechanical deformation of the patterned photoresist layer using a mechanical deformation model.
